(19) United States
(12) Patent Application Publication
(10) Pub. No.: US 2015/0177734 A1
(43) Pub. Date: Jun. 25, 2015

(54) METHOD AND EAR PROTECTION SYSTEM FOR MONITORING AN INDUSTRIAL PROCESS

(71) Applicant: ABB RESEARCH LTD, Zürich (CH)

(72) Inventors: Elina Vartiainen, Vasteras (SE); Fredrik Alfredsson, Vasteras (SE); Jonas Brönmark, Vasteras (SE); Martin Olausson, Vasteras (SE)

(73) Assignee: ABB RESEARCH LTD, Zürich (CH)

(21) Appl. No.: 14/408,015

(22) PCT Filed: Jun. 19, 2013
(86) PCT No.: PCT/EP2013/062795

§ 371 Date: Dec. 15, 2014

(30) Foreign Application Priority Data
Jul. 26, 2012 (EP) 12177929.2

(51) Int. Cl. G05B 23/00; H04R 29/00; H04R 5/033

(52) U.S. Cl. CPC G05B 23/00; H04R 5/033; H04R 29/00

(57) ABSTRACT

A method of monitoring an industrial process by means of an ear protection system having an ear protection unit with a left speaker and a right speaker includes obtaining a direction from which a sound is to be provided based on an angle between a coordinate system defined by the ear protection unit and a coordinate system defined by an industrial process environment of the industrial process, and on a location of the origin of the coordinate system of the ear protection unit in the coordinate system of the industrial process environment relative a location of an industrial process component in the coordinate system of the industrial process environment; obtaining real-time process variable data relating to at least one process variable of the industrial process component; and providing a 3-d sound that simulates an origination from the direction by means of at least one of the left speaker and the right speaker, which 3-d sound is indicative of a state of the industrial process component, wherein the 3-d sound simulates a realistic sound of the at least one process variable, reflecting a real-time state of the at least one process variable. An ear protection system carrying out the method is also presented herein.

### TECHNICAL FIELD

The present disclosure relates to a method and ear protection system for monitoring an industrial process.

### BACKGROUND

Industrial processes within industries such as oil and gas, pulp and paper, metals and mining, power generation, and petrochemical refineries utilise industrial process components, i.e. process equipment, for allowing the steps of the industrial process to be carried out. Such industrial process components may for example be tanks, valves, motors or controllers. The industrial process components together form an industrial process environment of an industrial process.

Process equipment is typically provided with one or more sensors measuring processes variables such that the industrial process may properly be monitored by a monitoring and control system. By means of the monitoring and control system the status of the various industrial process components of an industrial process may be monitored and controlled in real-time. The monitoring is typically provided in the form of process graphics presented on operator displays of e.g. a Supervisory Control And Data Acquisition system (SCADA). Monitoring can also be provided by means of display devices provided on industrial process components, arranged such that e.g. maintenance engineers may be able to inspect the condition and status of an industrial process component when the process engineer is located in an industrial process environment.

Alarm handling and awareness of the status of an industrial process component may involve communication between the operators in the control room and the maintenance engineer present in the industrial process environment. For example, alarm handling may require a maintenance engineer located in an industrial process environment to receive alarm information concerning an abnormal condition of an industrial process component from operators in the control room of the industrial process. Communication between the operator and maintenance engineer takes time, and is an inefficient way of allocating personnel resources.

DE 10 2008 021607 discloses a system provided with a model of a plant. Spatial coordinates are available for observed plant components. A specific aligned acoustic signal is available for conditions of a plant component in the model. An operator communicates binaural acoustic information about the localization or about the current condition of the plant component. In D₁, stereo headphones are used and their direction and distance from a system component can be determined. Spatial sound is created and the user is under the impression that the sound originates from a plant component. The sound from a system component is an alarm.

WO 2011/038838 discloses a machine classifier which classifies signals of an industrial plant and determines a current state as a result. On the basis of the current state, an audio profile is selected from a number of audio profiles and issued in the form of a synthetically generated acoustic signal to a plant operator. For that purpose, the state of the industrial plant is continuously evaluated and, for example, with the aid of a MIDI sequencer, is used to manipulate different tracks of a piece of music or of synthetically generated artificial background noise. The plant operator is thereby able discern divergences from a normal operation of the industrial plant. The plant operator can learn of the state of the industrial plant via the auditory sense or learn that in certain situations the industrial plant does not sound right.

DE 297 06151 discloses a device for acoustic signalling of faults and quality problems in different production zones of a production plant.

US 2008/249744 discloses a leakage diagnotor for use in a fluid leakage diagnosis. At a leading end of the gun-shaped diagnotor there are disposed a microphone and an optical beam source for detecting ultrasonic wave at a fluid leaking point. The diagnotor further includes earphones for outputting a detection sound which is an audible sound converted from the detected ultrasonic wave from the microphone. The diagnosis attendant leads the leading end of the diagnotor toward a detection target portion and while visually confirming an irradiated point p of the optical beam from the optical beam source, the attendant will gradually change the orientation of the leading end of the diagnotor. For each orientation, a leakage point, if any, is detected based on a detection value (sound pressure) of ultrasonic wave and a detection sound outputted from the earphone for each orientation.

### SUMMARY

In view of the above, it would be desirable to be able to provide a method and an ear protection system that allows for efficient alarm handling and status awareness of industrial process components for personnel located in an industrial process environment.

Hence, according to a first aspect of the present disclosure there is provided a method of monitoring an industrial process by means of an ear protection system having an ear protection unit with a left speaker and a right speaker, wherein the method comprises: obtaining a direction from which a sound is to be provided based on an angle between a coordinate system defined by the ear protection unit and a coordinate system defined by an industrial process environment of the industrial process, and on a location of the origin of the coordinate system of the ear protection unit in the coordinate system of the industrial process environment relative a location of an industrial process component in the coordinate system of the industrial process environment; obtaining real-time process variable data relating to at least one process variable of the industrial process component; and providing a 3-d sound that simulates an origination from the direction by means of at least one of the left speaker and the right speaker, which 3-d sound is indicative of a state of the industrial process component, wherein the 3-d sound simulates a realistic sound of the at least one process variable, reflecting a real-time state of the at least one process variable.

An effect obtainable thereby is that a user of the ear protection system may receive an indication of the state of the industrial process component which located in the obtained direction. Maintenance engineers may thereby be able to utilise their auditory senses for industrial process monitoring. In particular, the present disclosure provides industrial process monitoring by means of auditory augmented reality, with the sound being perceived to emanate from the direction of the industrial process component of interest.

One embodiment comprises obtaining a distance from the origin of the coordinate system of the ear protection unit in the coordinate system of the industrial process environment to the location of the industrial process component in the coordinate system of the industrial process environment, and prior to the step of providing the 3-d sound, determining an intensity of the 3-d sound based on the distance.

One embodiment comprises, prior to the step of obtaining the direction, receiving a selection of the industrial process component.

According to one embodiment the coordinate system of the industrial process is centred at the industrial process component that has been selected.

According to one embodiment the step of obtaining the direction is further based on an occurrence of an event at the industrial process component, wherein the 3-d sound is an alarm sound indicating the occurrence of the event.

One embodiment comprises obtaining real-time process variable data relating to at least one process variable of the industrial process component, wherein the 3-d sound simulates a realistic sound of the at least one process variable, reflecting a real-time state of the at least one process variable.

According to a second aspect of the present disclosure there is provided a computer program comprising computer-executable components for causing an ear protection unit to perform the steps recited in to the first aspect when the computer-executable components are run on a processor included in the ear protection unit.

According to a third aspect there is provided a computer program product comprising a computer readable medium, the computer readable medium having the computer program of the second aspect embodied therein.

According to a fourth aspect of the present disclosure there is provided an ear protection system for monitoring an industrial process, wherein the ear protection system comprises: an ear protection unit having a left speaker and a right speaker; and a processor arranged to obtain a direction from which a sound is to be generated based on an angle between a coordinate system defined by the ear protection unit and a coordinate system defined by an industrial process environment of the industrial process, and on a location of the origin of the coordinate system of the ear protection unit in the coordinate system of the industrial process environment relative a location of an industrial process component in the coordinate system of the industrial process environment, and to generate a 3-d sound that simulates an origination from the direction, which 3-d sound is indicative of a state of the industrial process component, wherein the left speaker and the right speaker are arranged to provide 3-d sound generated by the processor, wherein the processor is arranged to obtain real-time process variable data relating to at least one process variable of the industrial process component, wherein the 3-d sound simulates a realistic sound of the at least one process variable, reflecting a real-time state of the at least one process variable.

According to one embodiment the processor is arranged to obtain a distance from the origin of the coordinate system of the ear protection unit in the coordinate system of the industrial process environment to the location of the industrial process component in the coordinate system of the industrial process environment, and to determine an intensity of 3-d sound to be generated by the processor based on the distance.

According to one embodiment the processor is arranged to receive a selection of the industrial process component.

According to one embodiment the coordinate system of the industrial process is centred at the industrial process component that has been selected.

According to one embodiment the processor is arranged to obtain the direction further based on an occurrence of an event at the industrial process component, wherein the 3-d sound is an alarm sound indicating the occurrence of the event.

According to one embodiment the processor is arranged to obtain real-time process variable data relating to at least one process variable of the industrial process component, wherein the 3-d sound simulates a realistic sound of the at least one process variable, reflecting a real-time state of the at least one process variable.

Generally, all terms used in the claims are to be interpreted according to their ordinary meaning in the technical field, unless explicitly defined otherwise herein. All references to a/an/the element, apparatus, component, means, etc. are to be interpreted openly as referring to at least one instance of the element, apparatus, component, means, etc., unless explicitly stated otherwise. Moreover, any step in a method need not necessarily have to be carried out in the presented order, unless explicitly stated otherwise.

### BRIEF DESCRIPTION OF THE DRAWINGS

The specific embodiments of the inventive concept will now be described, by way of example, with reference to the accompanying drawings, in which:

FIGS. 1a-b shows examples of an ear protection system for monitoring an industrial process;

FIGS. 2a-b show coordinate systems of an ear protection unit and of an industrial process environment with the coordinate system of the ear protection unit depicted therein, respectively;

FIGS. 3a-b show examples of applications of the ear protection system in FIGS. 1a-b; and

FIG. 4 is a flowchart of methods of supervising an industrial process by means of an ear protection unit.

### DETAILED DESCRIPTION

The inventive concept will now be described more fully hereinafter with reference to the accompanying drawings, in which exemplifying embodiments are shown. The inventive concept may, however, be embodied in many different forms and should not be construed as limited to the to embodiments set forth herein; rather, these embodiments are provided by way of example so that this disclosure will be thorough and complete, and will fully convey the scope of the inventive concept to those skilled in the art. Like numbers refer to like elements throughout the description.

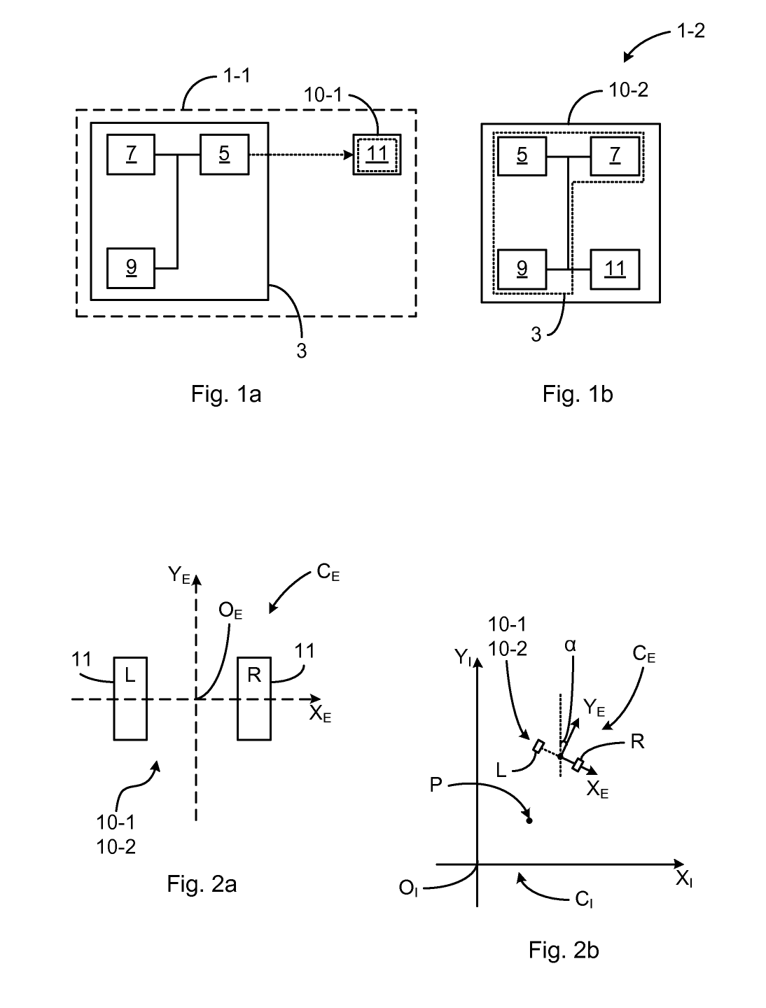

FIG. 1a depicts a first example of an ear protection system 1-1 comprising a mobile device 3 and an ear protection unit 10-1. An industrial process is to be understood to mean a procedure that involves chemical, electrical or mechanical steps to aid in manufacturing, production, power generation, fabrication, or refining. Examples of such industrial processes are processes relating to the refining of oil and gas, the petrochemical industry, power generation, power transmission, power distribution, metals and mining, chemical industry, pulp and paper, or automation in e.g. the manufacturing industry or food industry. An industrial process environment is an enclosed area in which chemical, electrical or mechanical steps of the industrial process are carried out. Examples of an industrial process environment are a plant floor or a substation.

The mobile device 3 comprises a processor 5, a memory 7, i.e. a computer readable medium having software stored therein which can be loaded into the processor to carry out the method presented herein, and an antenna 9. The mobile device 3 can for example be a smart phone, a tablet computer, or a portable device especially manufactured for use in an industrial process environment. The portion of the method presented herein and executed by the processor 5 may advantageously be implemented as a downloadable application if the mobile device 3 is embodied e.g. by a smart phone or a tablet computer.

The mobile device 3 is arranged to be connected to the ear protecting unit 10-1, e.g. an earmuff, which has two pads to protect the ears of a user of the ear protection unit 10-1. Each cap of the ear protection unit 10-1 comprises speakers 11 to allow the reproduction of 3 dimensional (3-d) sound or surround sound. The ear protection unit 10 may be connected to the mobile device 3 with a cord or cordlessly, e.g. by means of Bluetooth®.

FIG. 1b depicts a second example of an ear protection system. According to the second example, the functionality of the mobile device 3 is integrated with an ear protection unit 10-2, e.g. an earmuff. To that end, ear protection system 1-2 is embodied by ear protection unit 10-2, and comprises a processor 5, a memory 7, i.e. a computer readable medium having software stored therein which can be loaded into the processor to carry out the method presented herein, an antenna 9 and speakers 11.

According to one variation of each of the ear protection systems 1-1 and 1-2, the processor may be arranged to filter out ambient sound. According to this variation, the ear protection system of each of the first and the second example may comprise a microphone for recording ambient sound, wherein the processor may be arranged to create sound waves that interfere with the ambient sound so as provide a destructive interference effect.

Each of the ear protection systems 1-1 and 1-2 is arranged to wirelessly communicate, by means of antenna 9, with an industrial control system such as a Distributed Control System (DCS), a SCADA system or a combination of a SCADA system and DCS system. An example of an industrial control system for this purpose is the ABB® 800xA control system.

The processor 5 of ear protection system 1-1, 1-2 is arranged to obtain a direction from which a sound is to be generated in a coordinate system defined by ear protection unit 10-1 and 10-2, respectively, and to generate a 3-d sound that simulates an origination from the direction. The 3-d sound generated by the processor 5 provides an indication of a state of a specific industrial process component located in the direction from which the 3-d sound is simulated to originate from, thereby allowing a person wearing the ear protection unit 10-1, 10-2 to obtain an understanding of the current status or state of the industrial process component.

FIG. 2a shows a coordinate system C_{E} defined by ear protection unit 10-1, 10-2. The origin O_{E} of the coordinate system C_{E} is arranged at a centre point to between a left speaker L and a right speaker R of the ear protection unit 10-1, 10-2. The origin O_{E} of the coordinate system C_{E} defines the centre point of a soundscape that can be provided by the left speaker L and the right speaker R. The x-axis X_{E} of the coordinate system C_{E} goes straight through the centre points of the left speaker L and the right speaker R from a direction from the left speaker L to the right speaker R. The y-axis Y_{E} defines a reference axis along which sound is either perceived to be originating straight from behind or straight in front of a person wearing the ear protection unit 10-1, 10-2.

FIG. 2b shows a coordinate system C_{I} of an industrial process environment with the ear protection unit 10-1, 10-2 and thus the coordinate system C_{E} defined by the ear protection unit 10-1, 10-2 and an industrial process component P arranged in the coordinate system C_{I} of the industrial process environment. In the example in FIG. 2b the coordinate system C_{E} of the ear protection unit 10-1, 10-2 is arranged at an angle a relative the coordinate system C_{I} of the industrial process environment. A direction from which a 3-d sound is to be generated by the processor 5 of ear protection system 1-1, 1-2, which direction is the direction of the industrial process component P in the coordinate system C_{E} of the ear protection unit 10-1, 10-2, is obtained based on the angle a between the coordinate system C_{E} defined by the ear protection unit 10-1, 10-2 and the coordinate system C_{I} defined by the industrial process environment, and on a location of the origin O_{E} of the coordinate system C_{E} of the ear protection unit 10-1, 10-2 in the coordinate system C_{I} of the industrial process environment relative the location of the industrial process component P in the coordinate system C_{I} of the industrial process environment.

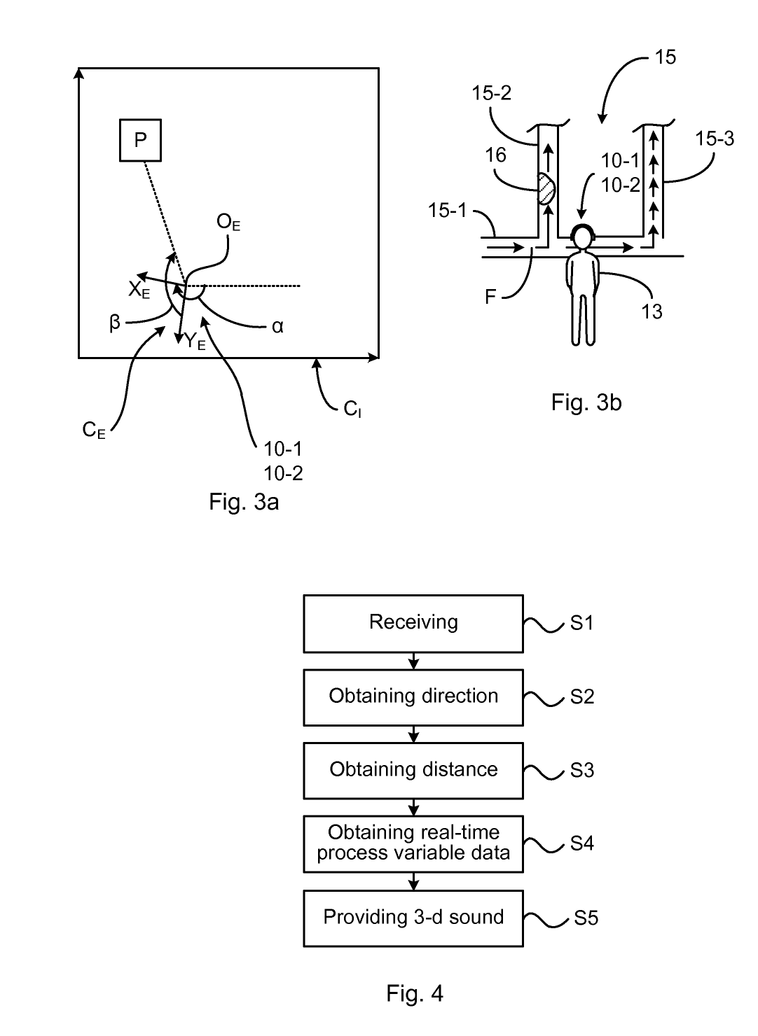

With reference to FIGS. 3a-b and FIG. 4, the operation of the ear protection system 1-1, 1-2 when monitoring an industrial process will now be described in more detail.

A user of the ear protection system 1-1, 1-2, which typically is a maintenance engineer, advantageously carries with him, or her, the ear protection system 1-1, 1-2 when situated in an industrial process environment to thereby be able to monitor the status of industrial process components arranged in the industrial process environment.

The industrial control system that is arranged to monitor and control the industrial process is arranged to receive process variable data relating to the process variables that are to be controlled by the industrial control system from a plurality of sensors arranged to measure the process variables of the industrial process.

According to one embodiment, in a step S₁ a selection of an industrial process component is received by the processor 5. Based on the selection, the processor 5 will generate a 3-d sound from the direction of the selected industrial process component in the coordinate system C_{E} of the ear protection unit 10-1, 10-2, as will be described below. The selection may for example be based on a user selection, wherein the processor 5 receives a user selection of an industrial process component which e.g. the maintenance engineer would like to examine. The selection may for example be obtained based on a direction in which the mobile device 3 or the ear protection unit 10-2 is oriented in the coordinate system C_{I} of the industrial process environment, by means of a Radio Frequency Identification (RFID) tag arranged on the industrial process component, a matrix barcode arranged on the industrial process component, or by means of special glasses worn by the user of the ear protection system, the glasses being arranged to provide an identification of industrial process components in an industrial process environment.

Alternatively, an industrial process component may be selected automatically by the industrial control system or the processor 5 when an event creating an alarm has occurred in the industrial process. Such a selection may thus be based on process variable values for example.

The coordinate system of the industrial process may be centred at the industrial process component that has been selected, or alternatively, it may be fixedly centred at a reference point in the industrial process environment.

A direction from which a 3-d sound is to be generated by the processor 5 is in a step S₂ obtained based on an angle α between the coordinate system C_{E} defined by the ear protection unit 10-1, 10-2 and the coordinate system C_{I} defined by the industrial process environment, and on a location of the origin O_{E} of the coordinate system C_{E} of the ear protection unit in the coordinate system of the industrial process environment C_{I} relative a location of the industrial process component in the coordinate system C_{I} of the industrial process environment. The location of the ear protection system 1-1, 1-2 in the industrial process environment coordinate system C_{I} may for example be obtained by means of a Global Navigation Satellite System (GNSS) such as the Global Positioning System (GPS), a Wi-Fi based positioning system or other suitable indoor positioning systems. The angle α between the coordinate system C_{E} of the ear protection unit 10-1, 10-2 and the coordinate system C_{I} of the industrial process environment can for example be determined by means of a gyroscope provided in the ear protection system 1-1, 1-2.

According to one variation, the location of the origin O_{E} may be determined by the processor 5 wherein the location or position is sent to the industrial control system such that the industrial control system may determine the direction in which the ear protection system 1-1, 1-2 is to generate a 3-d sound. The direction from which the 3-d sound is to be generated may thereby be obtained from the industrial control system. Alternatively, the direction from which a 3-d sound is to be generated may be obtained by the processor 5 determining the direction based on the same parameters as mentioned above. Alternatively, the ear protection system 1-1, 1-2 may be arranged to transmit signals which can be used by the industrial control system to determine the location or position of the ear protection unit 10-1, 10-2 wherein the location is determined by the industrial control system such that the industrial control system may determine the direction in which the ear protection system 1-1, 1-2 is to generate a 3-d sound. The direction from which the 3-d sound is to be generated may thereby be obtained from the industrial control system.

According to one embodiment, a distance from the origin O_{E} of the coordinate system C_{E} of the ear protection unit 10-1, 10-2 in the coordinate system C_{I} of the industrial process environment to the location of the industrial process component in the coordinate system C_{I} of the industrial process environment is obtained in a step S₃. An intensity of the 3-d sound to be generated by the processor 5 can according to such an embodiment be based on the distance. A user of the ear protection system 1-1, 1-2 may by means of the sound intensity be able to obtain an understanding of the distance to the industrial process component in question. The distance is advantageously updated as the ear protection unit 10-1, 10-2 moves, by being carried by its user, in the coordinate system C_{I} of the industrial process. Thereby the intensity of the 3-d sound that is provided can be varied based on the distance. It is to be noted that step S₃ may be performed prior to or after step S₂.

In a step S₅ a 3-d sound that simulates an origination from the direction by means of at least one of the left speaker and the right speaker is provided as it is generated or has been generated by the processor 5. The 3-d sound is indicative of a state of the industrial process component.

According to one embodiment, real-time process variable data relating to at least one process variable of the industrial process component is obtained in a step S₄, prior to step S₅ of providing a 3-d sound. The real-time process variable data may for example be provided by the industrial control system—The real-time process variable data may for example relate to a fluid flow in a pipe or the rate of combustion in a boiler. According to such an embodiment, the 3-d sound simulates a realistic sound of the at least one process variable, reflecting a real-time state of the at least one process variable. The processor 5 may generate a 3-d sound that has an origination that continuously moves in the coordinate system C_{E} of the ear protection unit 10-1, 10-2 reflecting a movement of the at least one process variable that it simulates. Hence, a to maintenance engineer may be able to hear a simulation of a fluid flowing from left to right in e.g. a pipe.

FIG. 3a shows an example where the coordinate system C_{E} defined by the ear protection unit 10-1, 10-2 is arranged at an angle a relative the coordinate system C_{I} of an industrial process environment. Based on the location of the origin O_{E} of the coordinate system C_{E} defined by the ear protection unit 10-1, 10-2 relative an industrial process component P that is subjected to an event, a direction, at an angle β in the coordinate system C_{E} of the ear protection unit 10-1, 10-2, from which a 3-d sound is to be generated by the processor 5 and provided by speakers 11 is obtained. The 3-d sound provided by the speakers 11 is an alarm sound indicating the occurrence of the event, the 3-d sound simulating an origination from the direction of the industrial process component P in the coordinate system C_{E} defined by the ear protection unit 10-1, 10-2. According to the example in FIG. 3a, the occurrence of the event triggered the selection of the industrial process component P, and thus the generation of the 3-d sound. Thereby, a maintenance engineer may be able to quickly become aware of the status of the industrial process component P and follow the direction, which is continually updated as the ear protection unit 10-1, 10-2 and thus the coordinate system C_{E} defined by the ear protection unit, moves in the coordinate system C_{I} of the industrial process environment, to arrive at the location of the industrial process component P and possible perform a mitigating action.

FIG. 3b shows an example where a maintenance engineer 13 stands in front of industrial process components in the form of a piping system 15 comprising a first pipe 15-1, a second pipe 15-2 and a third pipe 15-3, in which a fluid F flows. The maintenance engineer 13 may by means of the ear protection system 10-1, 10-2 select which one of the first pipe 15-1, a second pipe 15-2 and a third pipe 15-3 he would like to monitor or examine the status of. The second pipe 15-2 has been partially blocked by e.g. organic deposit 16 reducing the fluid flow in the second pipe 15-2. By selecting the second pipe 15-2, it is envisaged that the maintenance engineer will not only hear a to simulation of a fluid flow sound that is weaker than it should be if the second pipe 15-2 would function properly, but also that the direction of the fluid flow can be perceived by the user of the ear protection unit 10-1, 10-2. In the example of FIG. 3b, an upwardly flow direction would hence be heard by the maintenance engineer 13 wearing ear protection unit 10-1, 10-2. Thus, the maintenance engineer's awareness of the status of the industrial process component will be enhanced.

The inventive concept has mainly been described above with reference to a few examples. However, as is readily appreciated by a person skilled in the art, other embodiments than the ones disclosed above are equally possible within the scope of the inventive concept, as defined by the appended claims.

1. A method of monitoring an industrial process by means of an ear protection system having an ear protection unit with a left speaker and a right speaker, wherein the method comprises:
obtaining a direction from which a sound is to be provided based on an angle between a coordinate system defined by the ear protection unit and a coordinate system defined by an industrial process environment of the industrial process, and on a location of the origin of the coordinate system of the ear protection unit in the coordinate system of the industrial process environment relative a location of an industrial process component in the coordinate system of the industrial process environment,
obtaining real-time process variable data relating to at least one process variable of the industrial process component, and
providing a 3-d sound that simulates an origination from the direction by means of at least one of the left speaker and the right speaker, which 3-d sound is indicative of a state of the industrial process component, wherein the 3-d sound simulates a realistic sound of the at least one process variable, reflecting a real-time state of the at least one process variable.

2. The method as claimed in claim 1, comprising obtaining a distance from the origin of the coordinate system of the ear protection unit in the coordinate system of the industrial process environment to the location of the industrial process component in the coordinate system of the industrial process environment, and prior to the step of providing the 3-d sound, determining an intensity of the 3-d sound based on the distance.

3. The method as claimed in claim 1, comprising, prior to the step of obtaining the direction, receiving a selection of the industrial process component.

4. The method as claimed in claim 3, wherein the coordinate system of the industrial process is centred at the industrial process component that has been selected.

5. The method as claimed in claim 1, wherein the step of obtaining the direction is further based on an occurrence of an event at the industrial process component, wherein the 3-d sound is an alarm sound indicating the occurrence of the event.

6. A computer program comprising computer-executable components for causing an ear protection unit to perform the steps recited in claim 1 when the computer-executable components are run on a processor included in the ear protection unit.

7. A computer program product comprising a computer readable medium, the computer readable medium having the computer program according to claim 6 embodied therein.

8. An ear protection system for monitoring an industrial process, wherein the ear protection system comprises:
an ear protection unit having a left speaker and a right speaker, and
a processor arranged to obtain a direction from which a sound is to be generated based on an angle between a coordinate system defined by the ear protection unit and a coordinate system defined by an industrial process environment of the industrial process, and on a location of the origin of the coordinate system of the ear protection unit in the coordinate system of the industrial process environment relative a location of an industrial process component in the coordinate system of the industrial process environment, and to generate a 3-d sound that simulates an origination from the direction, which 3-d sound is indicative of a state of the industrial process component, wherein the left speaker and the right speaker are arranged to provide 3-d sound generated by the processor, wherein the processor is arranged to obtain real-time process variable data relating to at least one process variable of the industrial process component, wherein the 3-d sound simulates a realistic sound of the at least one process variable, reflecting a real-time state of the at least one process variable.

9. The ear protection system as claimed in claim 8, wherein the processor is arranged to obtain a distance from the origin of the coordinate system of the ear protection unit in the coordinate system of the industrial process environment to the location of the industrial process component in the coordinate system of the industrial process environment, and to determine an intensity of 3-d sound to be generated by the processor based on the distance.

10. The ear protection system as claimed in claim 8, wherein the processor is arranged to receive a selection of the industrial process component.

11. The ear protection system as claimed in claim 8, wherein the coordinate system of the industrial process is centred at the industrial process component that has been selected.

12. The ear protection system as claimed in claim 8, wherein the processor is arranged to obtain the direction further based on an occurrence of an event at the industrial process component, wherein the 3-d sound is an alarm sound indicating the occurrence of the event.

13. The method as claimed in claim 2, comprising, prior to the step of obtaining the direction, receiving a selection of the industrial process component.

14. The method as claimed in claim 2, wherein the step of obtaining the direction is further based on an occurrence of an event at the industrial process component, wherein the 3-d sound is an alarm sound indicating the occurrence of the event.

15. The method as claimed claim 3, wherein the step of obtaining the direction is further based on an occurrence of an event at the industrial process component, wherein the 3-d sound is an alarm sound indicating the occurrence of the event.

16. The method as claimed in claim 4, wherein the step of obtaining the direction is further based on an occurrence of an event at the industrial process component, wherein the 3-d sound is an alarm sound indicating the occurrence of the event.

17. The ear protection system as claimed in claim 9, wherein the processor is arranged to receive a selection of the industrial process component.

18. The ear protection system as claimed in claim 9, wherein the coordinate system of the industrial process is centred at the industrial process component that has been selected.

19. The ear protection system as claimed in claim 10, wherein the coordinate system of the industrial process is centred at the industrial process component that has been selected.

20. The ear protection system as claimed in claim 9, wherein the processor is arranged to obtain the direction further based on an occurrence of an event at the industrial process component, wherein the 3-d sound is an alarm sound indicating the occurrence of the event.
